(19) United States
(12) Patent Application Publication
(10) Pub. No.: US 2026/0254908 A1
(43) Pub. Date: Aug. 27, 2026

(54) IMAGE READING APPARATUS

(71) Applicant: SEIKO EPSON CORPORATION, Tokyo (JP)

(72) Inventors: Nobutaka UEMURA, KITAKYUSHU-SHI (JP); Masaki NAMIKI, KITAKYUSHU-SHI (JP)

(21) Appl. No.: 19/543,036

(22) Filed: Feb. 18, 2026

(30) Foreign Application Priority Data
Feb. 21, 2025 (JP) 2025-026417

(51) Int. Cl. H04N 1/00; B08B 1/14; B08B 1/30; H04N 1/028

(52) U.S. Cl. CPC H04N 1/00909; B08B 1/143; B08B 1/30; H04N 1/00798; H04N 1/02815; H04N 2201/0081

(57) ABSTRACT

An image reading apparatus includes: a reading unit including a reader and a light transmitting member; and a cleaning unit configured to clean the light transmitting member when coming into contact with the light transmitting member and moving on the light transmitting member, in which the cleaning unit includes a wiping portion that comes into contact with the light transmitting member, the wiping portion is movable from a standby position to a restriction position, and a range from the standby position to the restriction position for the wiping portion is a length including both end portions of a medium having a maximum size assumed to be used.

The present application is based on, and claims priority from JP Application Serial Number 2025-026417, filed February 21, 2025, the disclosure of which is hereby incorporated by reference herein in its entirety.

### BACKGROUND

### 1. Technical Field

The present disclosure relates to an image reading apparatus.

### 2. Related Art

In the related art, various image reading apparatuses that causes a reading unit to read an image on a medium being conveyed are used. In such an image reading apparatus, a foreign substance such as paper dust may remain or adhere to the reading unit. Therefore, for example, JP-A-2010-68248 discloses a configuration in which paper dust remaining or adhered to a reading position is swept by a brush.

JP-A-2010-68248 is an example of the related art.

An image reading apparatus disclosed in JP-A-2010-68248 has a configuration in which the brush sweeps paper dust to the outside of a reading glass of a reading unit in a conveyance path. However, in such a configuration, there is a concern that paper dust once discharged may enter the conveyance path of the medium and the like along with the conveyance of a new medium or the like. In this manner, in the image reading apparatus in the related art in which an image on a medium being conveyed is read by the reading unit, a light transmitting member of the reading unit may not be suitably cleaned.

### SUMMARY

In order to solve the above problems, an image reading apparatus according to the present disclosure includes: a reading unit including a reader configured to read an image on a medium conveyed in a first direction, and a light transmitting member disposed between the reader and a conveyance path through which the medium passes when the image on the medium is read by the reader; and a cleaning unit configured to clean the light transmitting member when coming into contact with the light transmitting member and moving on the light transmitting member in a second direction intersecting the first direction, in which the cleaning unit includes a wiping portion configured to come into contact with the light transmitting member, the wiping portion is movable in the second direction from a standby position located before start of cleaning to a restriction position where a movement in the second direction is restricted, and a range from the standby position to the restriction position for the wiping portion in the second direction is a length including both end portions of a medium having a maximum size in the second direction assumed to be used.

### BRIEF DESCRIPTION OF THE DRAWINGS

FIG. 1 is a side cross-sectional view showing an image reading apparatus according to Embodiment 1 of the present disclosure.

FIG. 2 is a side cross-sectional view showing the periphery of a reading unit of the image reading apparatus shown in FIG. 1.

FIG. 3 is a perspective view showing a wiping portion of a cleaning unit of the image reading apparatus shown in FIG. 1.

FIG. 4 is a plan view showing the periphery of a second reading unit of the reading unit of the image reading apparatus shown in FIG. 1.

FIG. 5 is a perspective view showing the periphery of the second reading unit of the image reading apparatus shown in FIG. 1.

FIG. 6 is a perspective view showing the periphery of the reading unit of the image reading apparatus shown in FIG. 1.

FIG. 7 is a perspective view showing the periphery of a moving unit of the reading unit of the image reading apparatus shown in FIG. 1, and is a view showing a state in which a first reading unit of the reading unit is at an approach position.

FIG. 8 is a perspective view showing the periphery of the moving unit of the reading unit of the image reading apparatus shown in FIG. 1, and is a view showing a state in which the first reading unit of the reading unit is at a retracted position.

FIG. 9 is a flowchart showing an example of a cleaning operation performed using the image reading apparatus shown in FIG. 1.

FIG. 10 is a perspective view showing the periphery of a moving unit of a reading unit of an image reading apparatus according to Embodiment 2 of the present disclosure, and is a view showing a state in which a first reading unit of the reading unit is at an approach position.

FIG. 11 is a perspective view showing the periphery of a moving unit of a reading unit of an image reading apparatus according to Embodiment 3 of the present disclosure, and is a view showing a state in which a first reading unit of the reading unit is at an approach position.

FIG. 12 is a perspective view showing the periphery of a moving unit of a reading unit of an image reading apparatus according to Embodiment 4 of the present disclosure, and is a view showing a state in which a first reading unit of the reading unit is at an approach position.

FIG. 13 is a perspective view showing the periphery of a moving unit of a reading unit of an image reading apparatus according to Embodiment 5 of the present disclosure, and is a view showing a state in which a first reading unit of the reading unit is at an approach position.

### DESCRIPTION OF EMBODIMENTS

First, an overview of the present disclosure will be described.

In order to solve the above problems, an image reading apparatus according to a first aspect of the present disclosure includes: a reading unit including a reader configured to read an image on a medium conveyed in a first direction, and a light transmitting member disposed between the reader and a conveyance path through which the medium passes when the image on the medium is read by the reader; and a cleaning unit configured to clean the light transmitting member when coming into contact with the light transmitting member and moving on the light transmitting member in a second direction intersecting the first direction, in which the cleaning unit includes a wiping portion configured to come into contact with the light transmitting member, the wiping portion is movable in the second direction from a standby position located before start of cleaning to a restriction position where a movement in the second direction is restricted, and a range from the standby position to the restriction position for the wiping portion in the second direction is a length including both end portions of a medium having a maximum size in the second direction assumed to be used.

According to the present aspect, the wiping portion of the cleaning unit is movable in the second direction from the standby position to the restriction position, and the range from the standby position to the restriction position in the second direction is a length including the both end portions of the medium having the maximum size in the second direction assumed to be used. With such a configuration, at least a portion of the reader that reads the image can be cleaned, and a foreign substance such as paper dust or dust can be moved to a region outside the conveyance path outside the portion in the second direction. Therefore, it is possible to reduce a possibility that a foreign substance remaining on the light transmitting member moves to and accumulates on the conveyance path due to repeated reading of an image on a subsequent medium. That is, the light transmitting member of the reading unit can be suitably cleaned.

The image reading apparatus according to a second aspect of the present disclosure is an aspect according to the first aspect, in which the reading unit includes a first reading unit that includes a first reader serving as the reader configured to read a first surface of the medium conveyed in the first direction and that includes a first light transmitting member serving as the light transmitting member disposed between the conveyance path and the first reader, and a second reading unit that includes a second reader serving as the reader configured to read a second surface opposite to the first surface and provided on an opposite side to the first reader across the conveyance path and that includes a second light transmitting member serving as the light transmitting member disposed between the conveyance path and the second reader, and the first reading unit and the second reading unit face each other across the conveyance path.

According to the present aspect, the reading unit includes the first reading unit that includes the first reader configured to read the first surface of the medium and the first light transmitting member, and the second reading unit that includes the second reader configured to read the second surface of the medium and provided on the opposite side to the first reader and the second light transmitting member, and the first reading unit and the second reading unit face each other across the conveyance path. With such a configuration, the first surface and the second surface of the medium can be read, the conveyance path can be shortened, and the apparatus can be miniaturized.

The image reading apparatus according to a third aspect of the present disclosure is an aspect according to the second aspect, in which the cleaning unit is configured to clean the first light transmitting member and the second light transmitting member at a same time.

According to the present aspect, the cleaning unit can clean the first light transmitting member and the second light transmitting member at the same time. With such a configuration, since a plurality of the reading units can be cleaned by one cleaning unit, the reading units can be cleaned in a short time with a simple configuration.

The image reading apparatus according to a fourth aspect of the present disclosure is an aspect according to the third aspect, in which a thickness of the wiping portion, which is a length in a facing direction in which the first reading unit and the second reading unit face each other when the wiping portion is not located between the first light transmitting member and the second light transmitting member, is larger than a distance between the first light transmitting member and the second light transmitting member in the facing direction.

According to the present aspect, the thickness of the wiping portion is larger than the distance between the first light transmitting member and the second light transmitting member in the facing direction. With such a configuration, the first reading unit and the second reading unit can be suitably cleaned by one cleaning unit.

The image reading apparatus according to a fifth aspect of the present disclosure is an aspect according to the third or fourth aspect, in which the wiping portion is configured to clean the first light transmitting member on a first cleaning surface that comes into contact with the first light transmitting member and clean the second light transmitting member on a second cleaning surface that comes into contact with the second light transmitting member.

According to the present aspect, the wiping portion can clean the first light transmitting member on the first cleaning surface that comes into contact with the first light transmitting member, and can clean the second light transmitting member on the second cleaning surface that comes into contact with the second light transmitting member. With such a configuration, since a plurality of the reading units can be suitably cleaned by one cleaning unit, the reading unit can be suitably cleaned in a short time with a simple configuration.

The image reading apparatus according to a sixth aspect of the present disclosure is an aspect according to the second aspect, in which the cleaning unit includes a first cleaning unit configured to clean the first light transmitting member and a second cleaning unit configured to clean the second light transmitting member.

According to the present aspect, the cleaning unit includes the first cleaning unit configured to clean the first light transmitting member and the second cleaning unit configured to clean the second light transmitting member. With such a configuration, since each reading unit can be suitably cleaned by each cleaning unit, for example, the cleaning unit can be brought into close contact with each light transmitting member regardless of the degree of consumption of the cleaning unit, and each reading unit can be suitably cleaned.

The image reading apparatus according to a seventh aspect of the present disclosure is an aspect according to any one of the first to sixth aspects, in which the cleaning unit includes a first drive motor that is a power source of the wiping portion, and a drive belt that pulls the wiping portion along with rotation of the first drive motor.

According to the present aspect, the cleaning unit includes the first drive motor that is the power source of the wiping portion, and the drive belt that pulls the wiping portion along with the rotation of the first drive motor. With such a configuration, the wiping portion can be automatically moved by power of the first drive motor, the number of times a user cleans the reading unit using a cleaning kit or the like can be reduced, and a time spent by the user for a cleaning operation of the reading unit can be shortened.

The image reading apparatus according to an eighth aspect of the present disclosure is an aspect according to any one of the first to seventh aspects, in which the wiping portion is movable from the restriction position to the standby position when the wiping portion is moved in a direction opposite to the second direction.

According to the present aspect, the wiping portion is movable from the restriction position to the standby position when the wiping portion is moved in the direction opposite to the second direction. With such a configuration, the light transmitting member can be wiped twice in a forward direction and a backward direction, and the reading unit can be suitably cleaned.

The image reading apparatus according to a ninth aspect of the present disclosure is an aspect according to any one of the first to eighth aspects, in which the restriction position overlaps the light transmitting member when viewed in a vertical direction.

According to the present aspect, the restriction position overlaps the light transmitting member when viewed in the vertical direction. Since the restriction position includes at least a position of an end portion on a downstream side in the second direction of the medium having the maximum size assumed to be used, by adopting such a configuration, the reading unit can be cleaned up to at least a portion that performs a reading operation without excessively widening a movement range of the wiping portion.

The image reading apparatus according to a tenth aspect of the present disclosure is an aspect according to any one of the first to ninth aspects, in which a detection unit is provided at the restriction position, and the wiping portion includes a detection target portion to be detected by the detection unit, and the movement in the second direction is stopped when the detection unit detects the detection target portion.

According to the present aspect, the detection unit is provided at the restriction position, the wiping portion includes the detection target portion, and the movement in the second direction is stopped when the detection unit detects the detection target portion. With such a configuration, the wiping portion can be accurately stopped at the restriction position.

The image reading apparatus according to an eleventh aspect of the present disclosure is an aspect according to any one of the first to tenth aspects, and further includes a moving unit configured to move the reading unit, in which the moving unit moves the reading unit in a direction of retracting from the conveyance path before the wiping portion starts moving from the standby position to the restriction position, and moves the reading unit in a direction of approaching the conveyance path after the wiping portion finishes moving from the restriction position to the standby position.

According to the present aspect, the image reading apparatus includes the moving unit configured to move the reading unit, and the moving unit moves the reading unit in the direction of retracting from the conveyance path before the wiping portion starts moving from the standby position to the restriction position, and moves the reading unit in the direction of approaching the conveyance path after the wiping portion finishes moving from the restriction position to the standby position. With such a configuration, a wide gap is formed between the reading unit and the conveyance path as the cleaning of the reading unit is started, and the wiping portion can enter the gap. That is, the standby position can be provided at a position other than a position facing the reading unit.

The image reading apparatus according to a 12th aspect of the present disclosure is an aspect according to the eleventh aspect, and further includes an operation unit configured to receive a cleaning instruction, in which when the operation unit receives the cleaning instruction, the reading unit is moved in the direction of retracting from the conveyance path.

According to the present aspect, the image reading apparatus includes the operation unit configured to receive the cleaning instruction, and when the operation unit receives the cleaning instruction, the reading unit is moved in the direction of retracting from the conveyance path. With such a configuration, it is possible to start cleaning in response to a cleaning instruction from a user.

The image reading apparatus according to a 13th aspect of the present disclosure is an aspect according to the 12th aspect, in which the operation unit is configured to notify information, and notifies completion of cleaning after the wiping portion finishes moving from the restriction position to the standby position.

According to the present aspect, the operation unit is configured to notify the information, and notifies the completion of cleaning after the wiping portion finishes moving from the restriction position to the standby position. With such a configuration, a user can recognize that cleaning is completed according to notification performed by the operation unit.

The image reading apparatus according to a 14th aspect of the present disclosure is an aspect according to the second aspect, and further includes a moving unit configured to move the reading unit, in which the moving unit moves the first reading unit in the direction of retracting from the conveyance path before the wiping portion starts moving from the standby position to the restriction position, and a distance between the first light transmitting member and the second light transmitting member when the moving unit moves the first reading unit in the direction of retracting from the conveyance path is a length in which both the first light transmitting member and the second light transmitting member are configured to come into contact with the wiping portion.

According to the present aspect, the image reading apparatus includes the moving unit configured to move the reading unit, the moving unit moves the first reading unit in the direction of retracting from the conveyance path before the wiping portion starts moving from the standby position to the restriction position, and the distance between the first light transmitting member and the second light transmitting member when the moving unit moves the first reading unit in the direction of retracting from the conveyance path is the length in which both the first light transmitting member and the second light transmitting member are configured to come into contact with the wiping portion. With such a configuration, the wiping portion can be suitably pressed against the light transmitting member, and the reading unit can be suitably cleaned.

The image reading apparatus according to a 15th aspect of the present disclosure is an aspect according to the eleventh aspect, in which the moving unit includes a lifting mechanism that lifts the reading unit vertically upward, a second drive motor that is a power source of the lifting mechanism, and a drive unit that transmits power of the second drive motor to the lifting mechanism, and the reading unit is moved in the direction of retracting from the conveyance path when the second drive motor is driven.

According to the present aspect, the moving unit includes the lifting mechanism that lifts the reading unit vertically upward, the second drive motor that is a power source of the lifting mechanism, and the drive unit that transmits the power of the second drive motor to the lifting mechanism, and the reading unit is moved in the direction of retracting from the conveyance path when the second drive motor is driven. With such a configuration, a wide gap is suitably formed between the reading unit and the conveyance path as cleaning of the reading unit is started, and the wiping portion can enter the gap.

The image reading apparatus according to a 16th aspect of the present disclosure is an aspect according to the 15th aspect, in which the lifting mechanism is provided at both ends of the reading unit in the second direction.

According to the present aspect, the lifting mechanism is provided at the both ends of the reading unit in the second direction. With such a configuration, the reading unit can be supported at at least two points in a state where the reading unit is lifted by the lifting mechanism, and the reading unit can be stably supported.

The image reading apparatus according to a 17th aspect of the present disclosure is an aspect according to the 15th or 16th aspect, in which the lifting mechanism is a cam.

According to the present aspect, the lifting mechanism is a cam. With such a configuration, the reading unit can be lifted vertically upward by the cam.

The image reading apparatus according to an 18th aspect of the present disclosure is an aspect according to the 15th or 16th aspect, in which the lifting mechanism is a rack and pinion mechanism.

According to the present aspect, the lifting mechanism is a rack and pinion mechanism. With such a configuration, the reading unit can be lifted vertically upward by the rack and pinion mechanism.

The image reading apparatus according to a 19th aspect of the present disclosure is an aspect according to the 15th or 16th aspect, in which the lifting mechanism includes a rotation body and an arm portion that is coupled to the rotation body and the reading unit and that moves the reading unit upward and downward along with rotation of the rotation body.

According to the present aspect, the reading unit can be lifted vertically upward by the lifting mechanism including the rotation body and the arm portion that is coupled to the rotation body and the reading unit and that moves the reading unit upward and downward along with the rotation of the rotation body.

### Embodiment 1

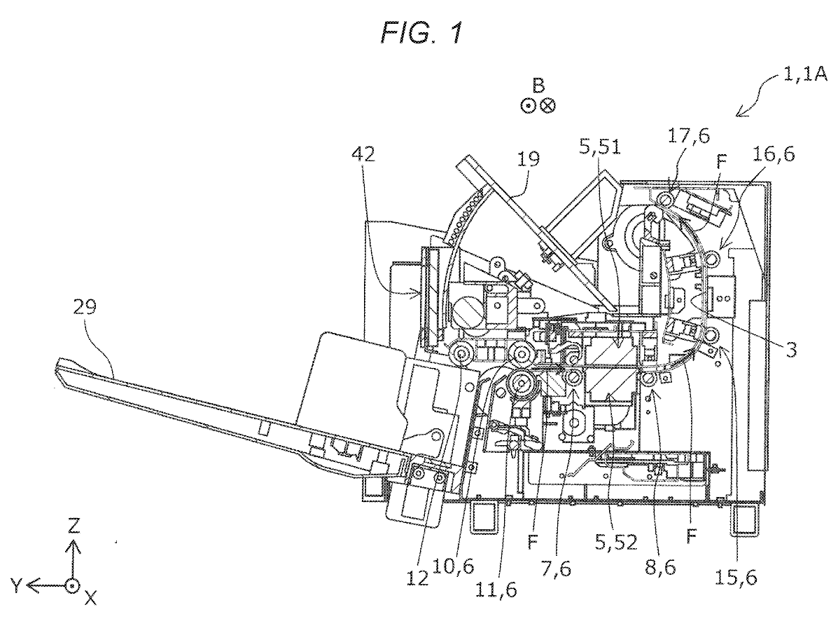

Hereinafter, an image reading apparatus 1A which is an embodiment of an image reading apparatus 1 of the present disclosure will be described with reference to FIGS. 1 to 9. First, an outline of the image reading apparatus 1A according to Embodiment 1 of the present disclosure will be described with reference to FIG. 1. In the following description, three axes orthogonal to one another are respectively represented as an X axis, a Y axis, and a Z axis as shown in the drawings. Directions indicated by arrows of the three axes (X, Y, and Z) are + directions of the directions and directions opposite to the + directions are - directions. A Z-axis direction is a direction corresponding to a vertical direction, that is, a direction in which the gravity acts, a +Z direction indicates a vertically upward direction, and a -Z direction indicates a vertically downward direction. An X-axis direction and a Y-axis direction correspond to a horizontal direction, and the X-axis direction corresponds to a width direction. A +Y direction indicates a front direction of the apparatus, and a -Y direction indicates a rear direction of the apparatus. A +X direction indicates a right direction of the apparatus, and a -X direction indicates a left direction of the apparatus.

The image reading apparatus 1A according to the present embodiment is a document scanner capable of reading an image formed on a medium. Here, the image formed on a medium refers to an image visually recorded on the medium, and is, for example, a character, a figure, a table, a picture, and a photograph. The medium is not limited to a sheet, and includes a card, a booklet, and the like. The image reading apparatus 1A of the present disclosure is not limited to a scanner and may be a copying machine, a facsimile machine, or the like.

The image reading apparatus 1A conveys a medium placed on a feed tray 29 in a conveyance direction F along a conveyance path 3, and causes a reading unit 5 to read an image on the medium being conveyed. As shown in FIG. 1, the image reading apparatus 1A includes a first reading unit 51 and a second reading unit 52 as the reading unit 5 that reads an image on a medium. The first reading unit 51 is located above the conveyance path 3 and reads an image on a first surface of the medium. The second reading unit 52 is located below the conveyance path 3 and reads an image on a second surface opposite to the first surface. The reading unit 5 includes, for example, a contact image sensor (CIS) type sensor or a charge coupled device (CCD) type sensor.

The image reading apparatus 1A includes a conveyance unit 6 that conveys a medium in the conveyance direction F along the conveyance path 3. The image reading apparatus 1A includes, as the conveyance unit 6, a conveyance roller pair 7 provided upstream of the first reading unit 51 and the second reading unit 52, and a conveyance roller pair 8 provided downstream of the first reading unit 51 and the second reading unit 52. The conveyance roller pair 7 and the conveyance roller pair 8 are implemented by a pair of a drive roller and a driven roller that rotate by power of a drive source such as a motor (not shown).

A feeding unit 10 and a separation unit 11 are disposed upstream of the conveyance roller pair 7 in the conveyance direction F. The feeding unit 10 is rotated by power of a motor (not shown) and conveys a medium in the conveyance direction F. The separation unit 11 includes a torque limiter and a separation roller that is rotated by power of a motor (not shown), and can separate a single medium from a plurality of media. A pick roller 12 is disposed upstream of the separation unit 11 in the conveyance direction F. The pick roller 12 is a drive roller that is rotated by power of a motor (not shown), picks a medium, and feeds the medium in the conveyance direction F.

The image reading apparatus 1A is provided with a straight path from the feeding unit 10 to the conveyance roller pair 8 and a U-turn path located downstream of the straight path. In the U-turn path, a conveyance roller pair 15, a conveyance roller pair 16, and a discharge roller pair 17, which serve as the conveyance unit 6, are disposed in this order along the conveyance direction F. The conveyance roller pair 15, the conveyance roller pair 16, and the discharge roller pair 17 are each implemented by a pair of a drive roller and a driven roller that are rotated by power of a motor (not shown). The image reading apparatus 1A includes a discharge tray 19 that receives a medium discharged from the discharge roller pair 17.

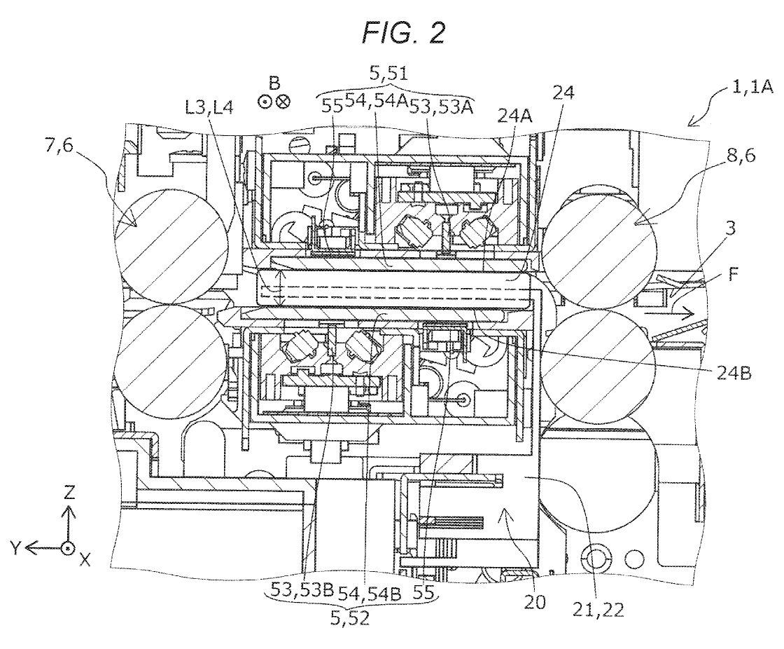

Here, details of the reading unit 5 will be described with reference to FIG. 2. As shown in FIG. 2, the image reading apparatus 1A includes the first reading unit 51 and the second reading unit 52 as the reading unit 5. The first reading unit 51 and the second reading unit 52 have substantially the same configuration except for an arrangement and whether a moving unit 60 of the first reading unit 51 is provided. The reading unit 5 includes both the first reading unit 51 and the second reading unit 52, a reader 53 that reads an image on a medium conveyed in the conveyance direction F which is a first direction, and a light transmitting member 54 that is a glass plate disposed between the reader 53 and the conveyance path 3 through which the medium passes when the image on the medium is read by the reader 53. A background plate 55 is provided at a position facing the reader 53 across the conveyance path 3. The background plate 55 is a reference plate that is read by a facing sensor for shading correction, and is, for example, white, gray, or black.

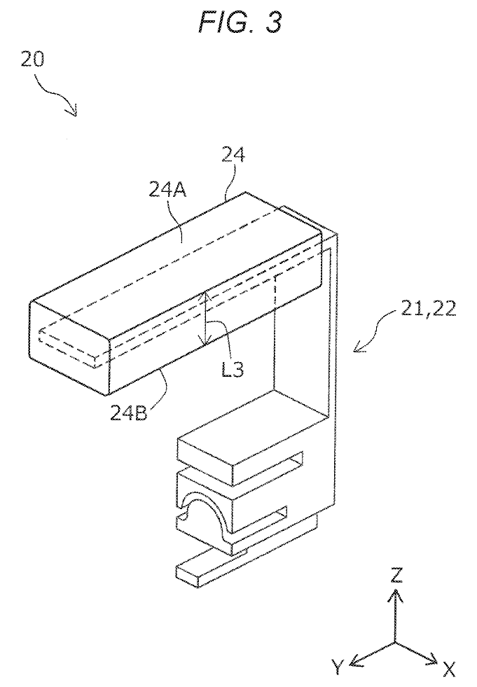

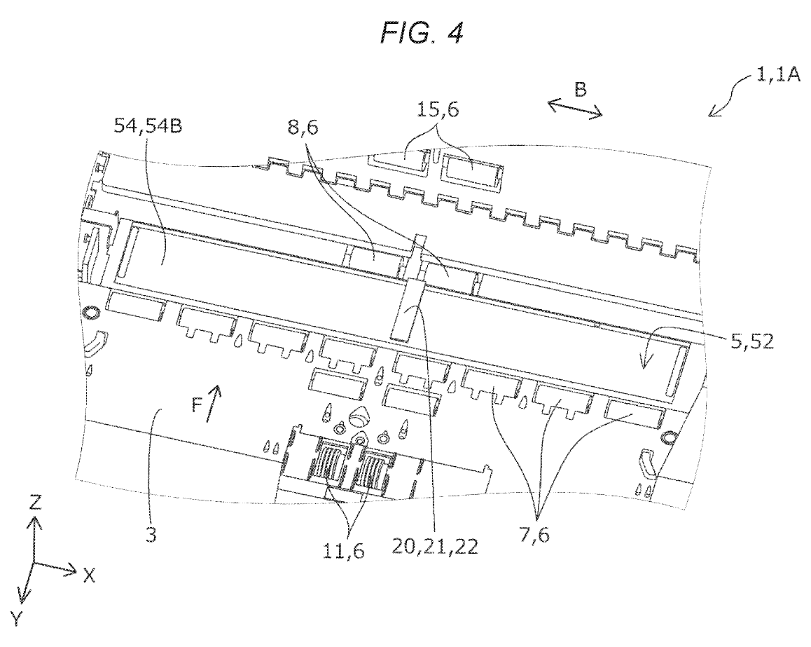

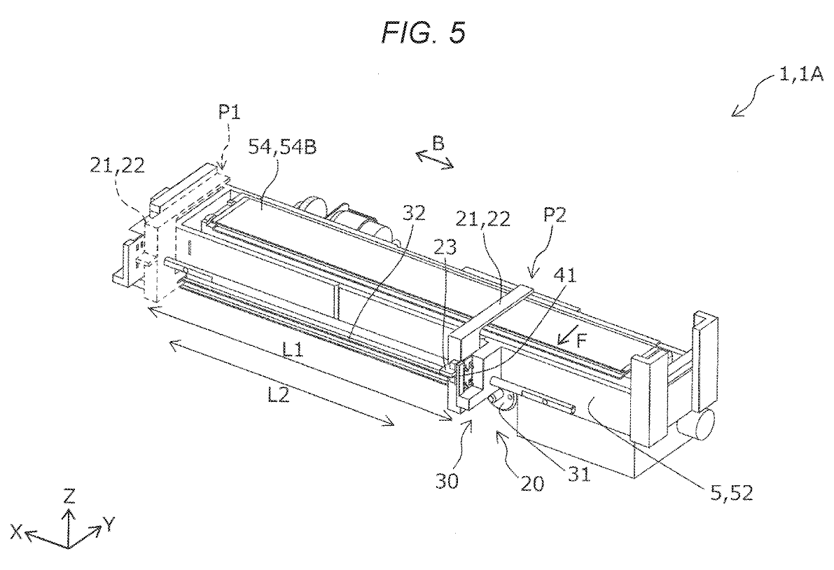

Further, the image reading apparatus 1A includes a cleaning unit 20 capable of cleaning the light transmitting member 54 when the cleaning unit 20 comes into contact with the light transmitting member 54 and moves on the light transmitting member 54 in a second direction (-X direction) corresponding to a width direction B intersecting the conveyance direction F. Hereinafter, the cleaning unit 20 will be described in detail with reference to FIGS. 3 to 8 in addition to FIG. 2. While FIGS. 2 and 3 show a state in which a contact portion 24 is attached to a wiping portion 21, FIGS. 4 and 5 show a state in which the contact portion 24 is not attached to the wiping portion 21.

As shown in FIG. 3, the cleaning unit 20 constitutes a moving body 22 that can reciprocate in the width direction B, and includes the wiping portion 21 that comes into contact with the light transmitting member 54. Specifically, as shown in FIG. 2, the contact portion 24, which is an elastic member such as a fabric, a brush, a nonwoven fabric, a microfiber, cotton, a sponge, paper, a comb skin, or a rubber wiper, is attached to the wiping portion 21 of the cleaning unit 20 in the present embodiment. The contact portion 24 can also be regarded as a component of the wiping portion 21. However, the present disclosure is not limited to such a configuration. The contact portion 24 may be implemented integrally with the wiping portion 21 as the moving body 22. The cleaning unit 20 may be configured to sweep out a foreign substance adhered to the light transmitting member 54, but is more preferably configured to wipe off a foreign substance adhered to the light transmitting member 54.

The cleaning unit 20 including the wiping portion 21 can move in the second direction (-X direction) along the width direction B from a standby position P1 located before the start of cleaning to a restriction position P2 where a movement in the second direction is restricted, as shown in FIG. 5. A range L1 from the standby position P1 to the restriction position P2 in the width direction B for the wiping portion 21 is larger than a width L2 of a medium having a maximum width assumed to be used. In other words, the range L1 from the standby position P1 to the restriction position P2 in the width direction B for the wiping portion 21 is a length including both end portions of the medium having the maximum size in the width direction B assumed to be used.

With such a configuration, the image reading apparatus 1A according to the present embodiment can clean at least a portion of the reader 53 that reads an image, and can move a foreign substance such as paper dust or dust to a region outside the portion in the width direction B (a region outside the conveyance path 3). Therefore, the image reading apparatus 1A can reduce the possibility that a foreign substance remaining on the light transmitting member 54 moves and accumulates on the conveyance path 3 due to repeated reading of an image on a subsequent medium. That is, the light transmitting member of the reading unit can be suitably cleaned.

Specifically, as shown in FIG. 2, the reading unit 5 according to the present embodiment includes the first reading unit 51 including a first reader 53A serving as the reader 53 capable of reading the first surface of a medium conveyed in the conveyance direction F serving as the first direction, and a first light transmitting member 54A serving as the light transmitting member 54 disposed between the conveyance path 3 and the first reader 53A. In addition, as shown in FIG. 2, the reading unit 5 according to the present embodiment includes the second reading unit 52 that includes a second reader 53B serving as the reader 53 capable of reading the second surface of the medium, which is the surface opposite to the first surface of the medium, and is the second reader 53B being provided on a side opposite to the first reader 53A across the conveyance path 3, and the second reading unit 52 includes a second light transmitting member 54B serving as the light transmitting member 54 disposed between the conveyance path 3 and the second reader 53B.

As shown in FIG. 2, the first reading unit 51 and the second reading unit 52 face each other across the conveyance path 3. With such a configuration, the first surface and the second surface of the medium can be read, the conveyance path 3 can be shortened, and the apparatus can be miniaturized. However, the present disclosure is not limited to such a configuration, and the first reading unit 51 and the second reading unit 52 may be disposed at positions shifted in the conveyance direction F.

In the image reading apparatus 1A according to the present embodiment, the cleaning unit 20 can clean the first light transmitting member 54A and the second light transmitting member 54B at the same time. With such a configuration, since a plurality of the reading units 5 can be cleaned by one cleaning unit 20, the reading units 5 can be cleaned in a short time with a simple configuration.

Specifically, in the image reading apparatus 1A according to the present embodiment, as shown in FIG. 3, a thickness L3 of the contact portion 24 of the wiping portion 21, which is a length in a facing direction (Z-axis direction) in which the first reading unit 51 and the second reading unit 52 face each other when the wiping portion 21 is not located between the first light transmitting member 54A and the second light transmitting member 54B, is larger than a distance L4 between the first light transmitting member 54A and the second light transmitting member 54B in the Z-axis direction shown in FIG. 2. With such a configuration, the first reading unit 51 and the second reading unit 52 can be suitably cleaned by one cleaning unit 20.

The distance L4 corresponds to a distance between the first light transmitting member 54A and the second light transmitting member 54B during cleaning. In addition, in FIG. 2, during cleaning, the thickness L3 represents a thickness of the contact portion 24 of the wiping portion 21, and is equal to the distance L4 since the wiping portion 21 enters between the first light transmitting member 54A and the second light transmitting member 54B, but the thickness L3 is larger than the distance L4 in a state in which the wiping portion 21 is not set in the image reading apparatus 1 as shown in FIG. 3 and a state such as during non-cleaning.

As shown in FIG. 2, the wiping portion 21 can clean the first light transmitting member 54A on a first cleaning surface 24A of the contact portion 24 that comes into contact with the first light transmitting member 54A, and can clean the second light transmitting member 54B on a second cleaning surface 24B of the contact portion 24 that comes into contact with the second light transmitting member 54B. With such a configuration, since the plurality of the reading units 5 can be suitably cleaned by one cleaning unit 20, the reading units 5 can be suitably cleaned in a short time with a simple configuration.

As described above, in the image reading apparatus 1A according to the present embodiment, the cleaning unit 20 can clean the first light transmitting member 54A and the second light transmitting member 54B at the same time by one moving body 22. However, the present disclosure is not limited to such a configuration. The moving body 22 that cleans the first light transmitting member 54A and the moving body 22 that cleans the second light transmitting member 54B may be provided separately. In other words, the cleaning unit 20 may include a first cleaning unit that can clean the first light transmitting member 54A and a second cleaning unit that can clean the second light transmitting member 54B. With such a configuration, since each reading unit 5 can be suitably cleaned by each cleaning unit 20, for example, the contact portion 24 of the cleaning unit 20 can be brought into close contact with each light transmitting member 54 regardless of the degree of consumption of the cleaning unit 20, and each reading unit 5 can be suitably cleaned.

As shown in FIG. 5, the cleaning unit 20 according to the present embodiment includes a moving body moving unit 30 that moves the moving body 22 in the width direction B. The moving body moving unit 30 includes a first drive motor 31 that is a power source of the wiping portion 21, and a drive belt 32 that pulls the wiping portion 21 along with rotation of the first drive motor 31. With such a configuration, the wiping portion 21 can be automatically moved by the power of the first drive motor 31, the number of times a user cleans the reading unit 5 using a cleaning kit or the like can be reduced, and a time spent by the user for a cleaning operation of the reading unit 5 can be shortened.

The wiping portion 21 according to the present embodiment can be moved from the restriction position P2 to the standby position P1 in a direction (+X direction) opposite to the second direction. With such a configuration, the light transmitting member 54 can be wiped twice in a forward direction and a backward direction, and the reading unit 5 can be suitably cleaned.

As shown in FIG. 5, in the image reading apparatus 1A according to the present embodiment, the restriction position P2 is disposed at a position overlapping the light transmitting member 54 when viewed in the vertical direction. As described above, in the image reading apparatus 1A according to the present embodiment, since the restriction position P2 includes at least a position of an end portion on a downstream side in the width direction (-X direction) of the medium having the maximum size assumed to be used, by adopting such a configuration, the reading unit 5 can be cleaned up to at least a portion that performs a reading operation without excessively widening a movement range of the wiping portion 21. Further, since it is not necessary to provide a member such as a detection unit 41 to be described later outside the light transmitting member 54, a space therefor is not necessary. However, the present disclosure is not limited to such a configuration, and the restriction position P2 may be located outside a formation range of the light transmitting member 54 in the width direction B.

As shown in FIG. 5, in the image reading apparatus 1A according to the present embodiment, the detection unit 41 is provided at the restriction position P2, and the wiping portion 21 includes a detection target portion 23 to be detected by the detection unit 41. The image reading apparatus 1A according to the present embodiment is configured such that the movement in the second direction (-X direction) is stopped when the detection unit 41 detects the detection target portion 23. With such a configuration, the image reading apparatus 1A according to the present embodiment can accurately stop the wiping portion 21 at the restriction position P2.

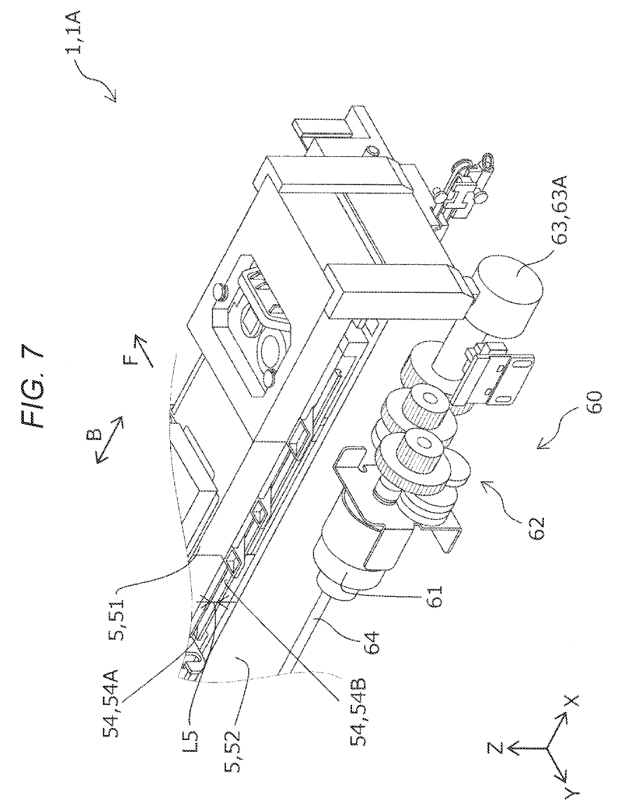

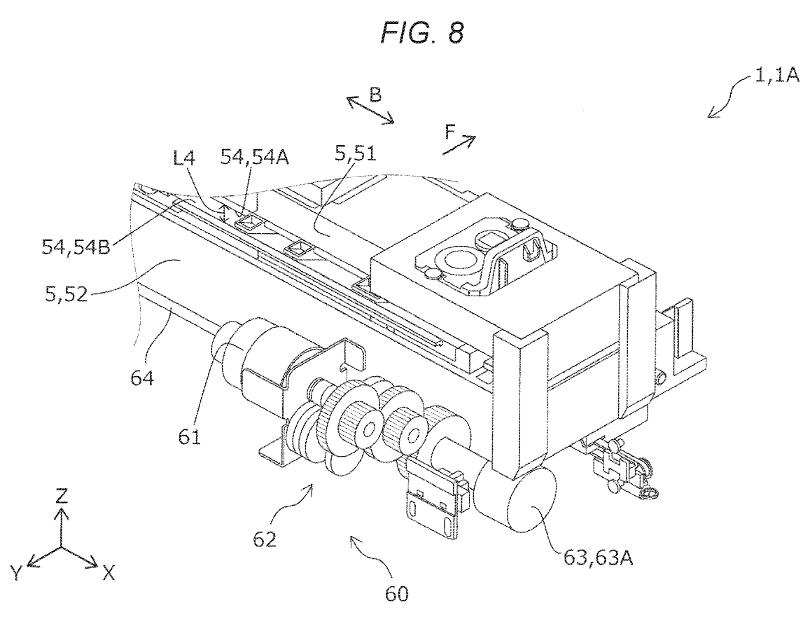

As described above, the image reading apparatus 1A according to the present embodiment includes the moving unit 60 that moves the reading unit 5. The moving unit 60 moves the first reading unit 51 of the reading unit 5 in the direction (+Z direction) of retracting from the conveyance path 3 as shown in FIG. 8 before the wiping portion 21 serving as the moving body 22 starts moving from the standby position P1 to the restriction position P2, and moves the first reading unit 51 in the direction (-Z direction) of approaching the conveyance path 3 as shown in FIG. 7 after the wiping portion 21 finishes moving from the restriction position P2 to the standby position P1. With such a configuration, a wide gap is formed between the reading unit 5 and the conveyance path 3 as cleaning of the reading unit 5 is started, and the wiping portion 21 can enter the gap. That is, the standby position P1 can be provided at a position other than a position facing the reading unit 5.

Here, as shown in FIG. 1, the image reading apparatus 1A according to the present embodiment includes an operation panel 42 serving as an operation unit. The operation panel 42 can receive a cleaning instruction from a user, and when the operation panel 42 receives the cleaning instruction, the first reading unit 51 of the reading unit 5 is moved in the direction of retracting from the conveyance path 3. With such a configuration, it is possible to start cleaning in response to a cleaning instruction from a user.

Further, the operation panel 42 can notify information, and notify completion of cleaning after the wiping portion 21 finished moving from the restriction position P2 to the standby position P1. Since the image reading apparatus 1A according to the present embodiment has such a configuration, the user can recognize that the cleaning is completed according to notification performed by the operation panel 42.

Further, in the image reading apparatus 1A according to the present embodiment, a distance L5 between the first light transmitting member 54A and the second light transmitting member 54B when the moving unit 60 shown in FIG. 7 moves the first reading unit 51 in the direction of approaching the conveyance path 3 is shorter than the thickness L3 of the contact portion 24 of the wiping portion 21, which is the length in the facing direction (Z-axis direction) in which the first reader 53A and the second reader 53B face each other when the wiping portion 21 is not located between the first light transmitting member 54A and the second light transmitting member 54B. Further, the distance L4 between the first light transmitting member 54A and the second light transmitting member 54B when the moving unit 60 shown in FIGS. 2 and 8 moves the first reading unit 51 in the direction of retracting from the conveyance path 3 is also shorter than the thickness L3 of the contact portion 24 of the wiping portion 21, which is the length in the facing direction (Z-axis direction) in which the first reader 53A and the second reader 53B face each other when the wiping portion 21 is not located between the first light transmitting member 54A and the second light transmitting member 54B. In other words, at least the distance L4 is a length at which both the first light transmitting member 54A and the second light transmitting member 54B can come into contact with the wiping portion 21 when the wiping portion 21 is located between the first light transmitting member 54A and the second light transmitting member 54B. With such a configuration, the wiping portion 21 can be suitably pressed against the light transmitting member 54, and the reading unit 5 can be suitably cleaned.

In the image reading apparatus 1A according to the present embodiment, the first light transmitting member 54A of the first reading unit 51 and a member holding the first light transmitting member 54A are biased vertically downward (-Z direction) by a spring (not shown). Then, the first light transmitting member 54A can be moved vertically upward by a certain distance by being pushed vertically upward (+Z direction). Therefore, even when the distance L4 is shorter than the thickness L3 of the contact portion 24 of the wiping portion 21, the wiping portion 21 can enter between the first reader 53A and the second reader 53B. In a case where the first light transmitting member 54A does not have such a configuration, when the contact portion 24 attached to the wiping portion 21 is made of a soft material, even if the distance L4 is shorter than the thickness L3 of the contact portion 24 of the wiping portion 21, the contact portion 24 is crushed and the wiping portion 21 can enter between the first reader 53A and the second reader 53B. The fact that the distance L4 or the distance L5 is shorter than the thickness L3 includes any one of the above configurations.

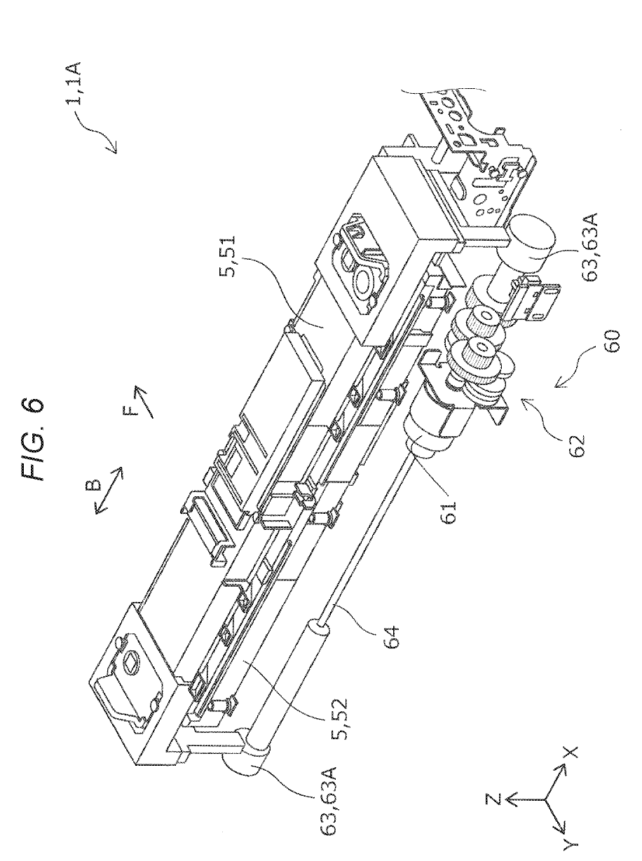

In the image reading apparatus 1A according to the present embodiment, as shown in FIGS. 6 to 8, the moving unit 60 includes lifting mechanisms 63 that lift the first reading unit 51 of the reading unit 5 vertically upward (+Z direction), a second drive motor 61 that is a power source of the lifting mechanism 63, and a drive unit 62 that transmits power of the second drive motor 61 to the lifting mechanism 63. When the second drive motor 61 is driven, the first reading unit 51 is moved in the direction (+Z direction) of retracting from the conveyance path 3. With such a configuration, in the image reading apparatus 1A according to the present embodiment, a wide gap can be suitably formed between the reading unit 5 and the conveyance path 3 as the cleaning of the reading unit 5 is started, and the wiping portion 21 can enter the gap.

In the image reading apparatus 1A according to the present embodiment, the first drive motor 31 and the second drive motor 61 are motors different from the motor which is the drive source of the conveyance unit 6. With such a configuration, it is possible to widely set a movement timing of the wiping portion 21 and a movement timing of the first reading unit 51.

In the image reading apparatus 1A according to the present embodiment, as shown in FIG. 6, the lifting mechanisms 63 are provided at both ends of the reading unit 5 in the width direction B. With such a configuration, the reading unit 5 can be supported at at least two points in a state where the reading unit 5 is lifted by the lifting mechanisms 63, and the reading unit 5 can be stably supported.

Here, the lifting mechanism 63 in the image reading apparatus 1A according to the present embodiment is a cam 63A as shown in FIGS. 6 to 8. With such a configuration, the first reading unit 51 of the reading unit 5 can be lifted vertically upward (+Z direction) by the cam 63A. The cam 63A in the present embodiment is an eccentric cam that is eccentric with respect to a rotation shaft 64 that rotates by the power of the second drive motor 61.

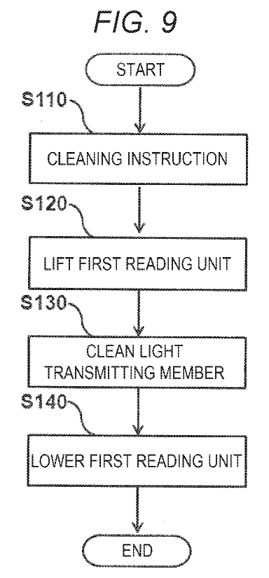

Hereinafter, an example of a cleaning operation performed using the image reading apparatus shown in FIG. 1 will be described with reference to a flowchart in FIG. 9. In the cleaning operation shown in the flowchart of FIG. 9, first, in step S110, a cleaning instruction from a user is received. The reception of the cleaning instruction is performed by the user inputting the cleaning instruction on the operation panel 42 or an external computer (not shown).

Next, in step S120, the first reading unit 51 is lifted vertically upward (+Z direction) to move the first reading unit 51 to a retracted position as shown in FIG. 8. Thereafter, in step S130, the light transmitting member 54 of the reading unit 5 is cleaned by causing the wiping portion 21 to reciprocate in the width direction B from the standby position P1 to the restriction position P2 and from the restriction position P2 to the standby position P1. Thereafter, in step S140, the first reading unit 51 is moved to an approach position as shown in FIG. 7, and the cleaning operation shown in the flowchart of FIG. 9 ends.

### Embodiment 2

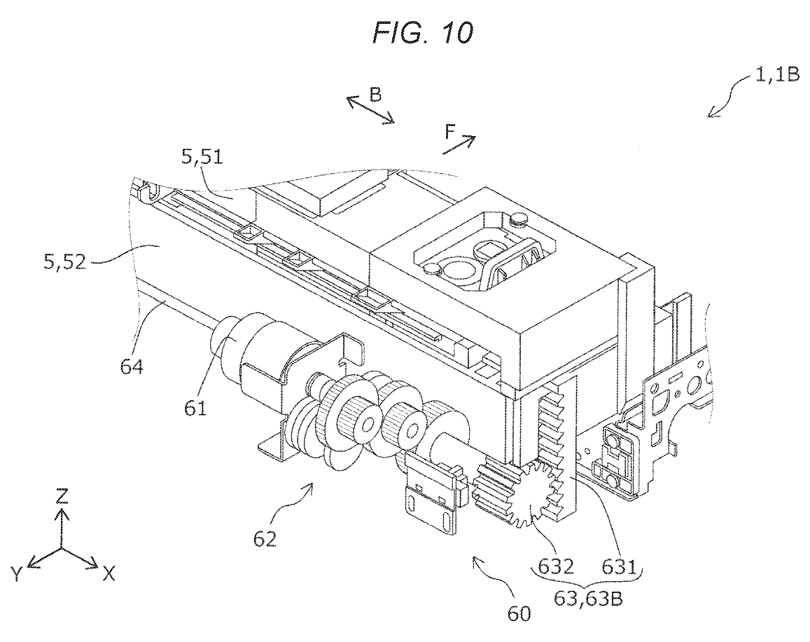

Next, an image reading apparatus 1B according to Embodiment 2 will be described with reference to FIG. 10. FIG. 10 corresponds to FIG. 7 showing the image reading apparatus 1A according to Embodiment 1. In FIG. 10, elements common to those in Embodiment 1 described above are denoted by the same reference numerals, and detailed description thereof will be omitted. Here, the image reading apparatus 1B according to the present embodiment has a configuration similar to the image reading apparatus 1A according to Embodiment 1 except for a configuration of the lifting mechanism 63. The image reading apparatus 1B according to the present embodiment therefore has the same features as the image reading apparatus 1A according to Embodiment 1 except for the following portions.

As described above, the lifting mechanism 63 of the image reading apparatus 1A according to Embodiment 1 is the cam 63A. On the other hand, as shown in FIG. 10, the lifting mechanism 63 of the image reading apparatus 1B according to the present embodiment is a rack and pinion mechanism 63B including a rack 631 and a pinion 632 that rotates together with the rotation shaft 64. With such a configuration, the first reading unit 51 of the reading unit 5 can be lifted vertically upward (+Z direction) by the rack and pinion mechanism 63B.

### Embodiment 3

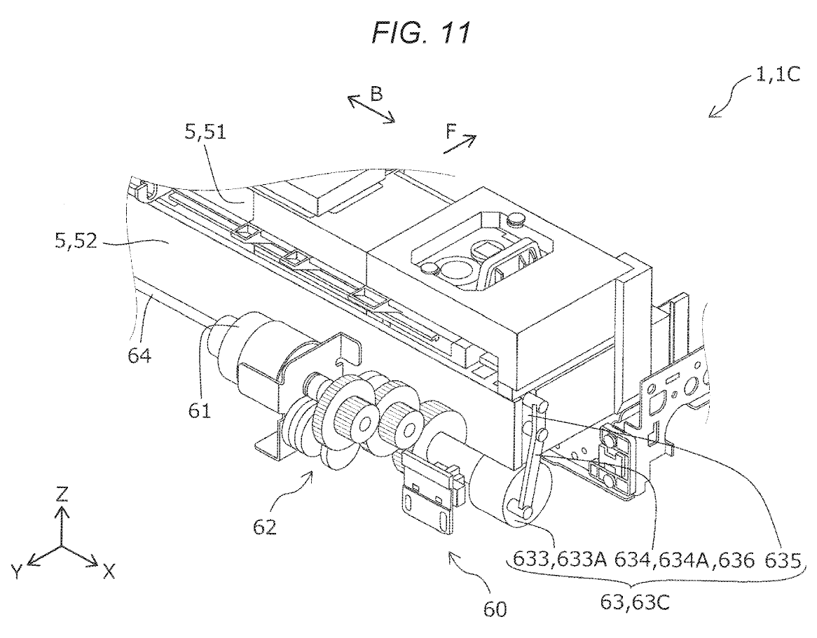

Next, an image reading apparatus 1C according to Embodiment 3 will be described with reference to FIG. 11. FIG. 11 corresponds to FIG. 7 showing the image reading apparatus 1A according to Embodiment 1. In FIG. 11, elements common to those in Embodiments 1 and 2 described above are denoted by the same reference numerals, and detailed description thereof will be omitted. Here, the image reading apparatus 1C according to the present embodiment has a configuration similar to the image reading apparatuses 1 according to Embodiments 1 and 2 except for a configuration of the lifting mechanism 63. The image reading apparatus 1C according to the present embodiment therefore has the same features as the image reading apparatuses 1 according to Embodiments 1 and 2 except for the following portions.

As described above, the lifting mechanism 63 of the image reading apparatus 1A according to Embodiment 1 is the cam 63A, and the lifting mechanism 63 of the image reading apparatus 1B according to Embodiment 2 is the rack and pinion mechanism 63B. On the other hand, as shown in FIG. 11, a lifting mechanism 63C of the image reading apparatus 1 according to the present embodiment includes a rotation body 633 (rotation body 633A) that rotates together with the rotation shaft 64, and an arm portion 634 (arm portion 634A) that is coupled to the rotation body 633A and the reading unit 5 (first reading unit 51) and that moves the first reading unit 51 upward and downward along with rotation of the rotation body 633A. One end of the arm portion 634A is coupled to a position of the rotation body 633A eccentric with respect to the rotation shaft 64, and the other end of the arm portion 634A coupled to the first reading unit 51 moves upward and downward along with the rotation of the rotation body 633A.

That is, the image reading apparatus 1C according to the present embodiment can lift the reading unit 5 vertically upward by the lifting mechanism 63C including the rotation body 633 and the arm portion 634 that is coupled to the rotation body 633 and the reading unit 5 and that moves the reading unit 5 upward and downward along with the rotation of the rotation body 633. The lifting mechanism 63 according to the present embodiment can be regarded as a cylinder crank mechanism including a cylinder 635 and a crank 636 (lifting mechanism 63C).

### Embodiment 4

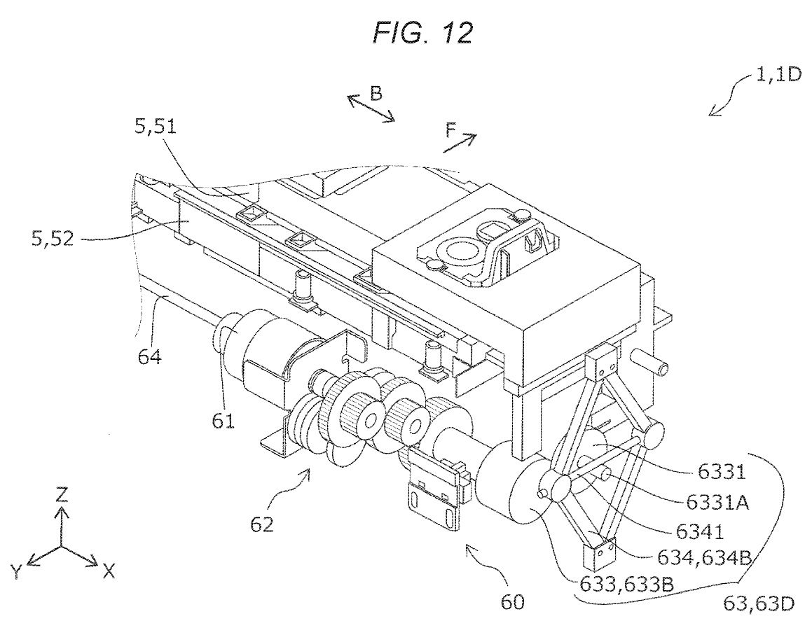

Next, an image reading apparatus 1D according to Embodiment 4 will be described with reference to FIG. 12. FIG. 12 corresponds to FIG. 8 showing the image reading apparatus 1A according to Embodiment 1. In FIG. 12, elements common to those in Embodiments 1 to 3 described above are denoted by the same reference numerals, and detailed description thereof will be omitted. Here, the image reading apparatus 1D according to the present embodiment has a configuration similar to the image reading apparatus 1 according to Embodiments 1 to 3 except for a configuration of the lifting mechanism 63. The image reading apparatus 1D according to the present embodiment therefore has the same features as the image reading apparatuses 1 according to Embodiments 1 to 3 except for the following portions.

As shown in FIG. 12, a lifting mechanism 63D of the image reading apparatus 1 according to the present embodiment includes the rotation body 633 (rotation body 633B) that rotates together with the rotation shaft 64, and the arm portion 634 (arm portion 634B) that is coupled to the rotation body 633B and the reading unit 5 (first reading unit 51) and that moves the first reading unit 51 upward and downward along with rotation of the rotation body 633B. The arm portion 634B has a pantograph structure, one end of the arm portion 634B in the Y-axis direction is coupled to a position of the rotation body 633B eccentric with respect to the rotation shaft 64, and when the rotation body 633B rotates, the arm portion 634B having the pantograph structure is bent and extended in the Y-axis direction, and one end of the arm portion 634B coupled to the first reading unit 51 in the Z-axis direction moves upward and downward.

That is, the image reading apparatus 1D according to the present embodiment can lift the reading unit 5 vertically upward by the lifting mechanism 63D including the rotation body 633 and the arm portion 634 that is coupled to the rotation body 633 and the reading unit 5 and that moves the reading unit 5 upward and downward along with the rotation of the rotation body 633. The arm portion 634B can be regarded as a link mechanism having a pantograph structure.

Specifically, as shown in FIG. 12, the image reading apparatus 1D according to the present embodiment includes a rotation body 6331 and a rotation shaft 6341 in the lifting mechanism 63D. Here, the rotation body 6331 has a rotation protrusion 6331A in which a spiral groove is formed, and engages with the rotation body 633B and rotates along with the rotation of the rotation body 633B. In addition, the rotation shaft 6341 is formed with a spiral groove, can bend and extend the arm portion 634B in the Y-axis direction when the rotation shaft 6341 rotates, the spiral groove of the rotation shaft 6341 engages with the spiral groove of the rotation protrusion 6331A, and the rotation shaft 6341 rotates along with rotation of the rotation protrusion 6331A.

### Embodiment 5

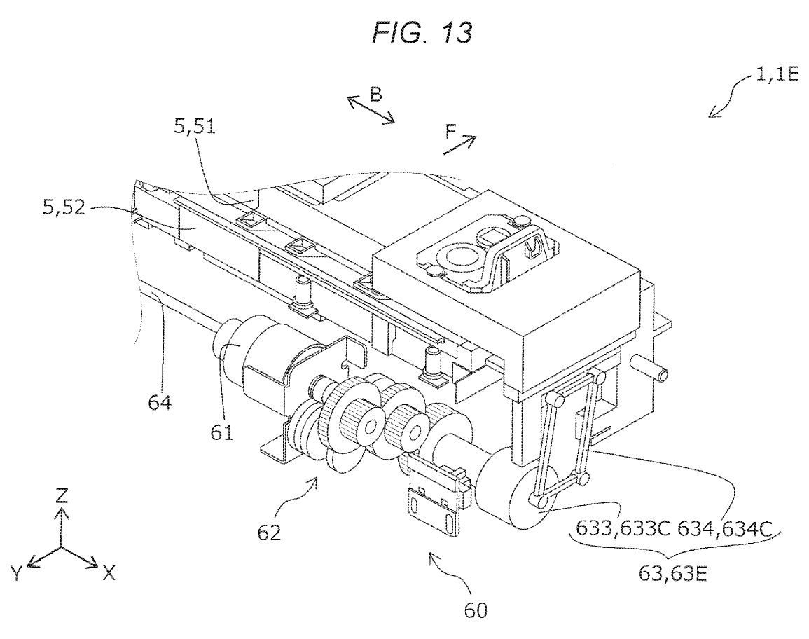

Next, an image reading apparatus 1E according to Embodiment 5 will be described with reference to FIG. 13. FIG. 13 corresponds to FIG. 8 showing the image reading apparatus 1A according to Embodiment 1. In FIG. 13, elements common to those in Embodiments 1 to 4 described above are denoted by the same reference numerals, and detailed description thereof will be omitted. Here, the image reading apparatus 1E according to the present embodiment has a configuration similar to the image reading apparatus 1 according to Embodiments 1 to 4 except for a configuration of the lifting mechanism 63. The image reading apparatus 1E according to the present embodiment therefore has the same features as the image reading apparatuses 1 according to Embodiments 1 to 4 except for the following portions.

As shown in FIG. 13, a lifting mechanism 63E of the image reading apparatus 1 according to the present embodiment includes the rotation body 633 (rotation body 633C) that rotates together with the rotation shaft 64, and the arm portion 634 (arm portion 634C) that is coupled to the rotation body 633C and the reading unit 5 (first reading unit 51) and that moves the first reading unit 51 upward and downward along with rotation of the rotation body 633C. The arm portion 634C has a so-called parallel link structure in which a parallelogram is formed by long arms and short arms, a corner portion of the parallelogram is coupled to the rotation body 633C, and when the rotation body 633C rotates, the parallelogram rotates and a position where the first reading unit 51 is placed is moved upward and downward.

That is, the image reading apparatus 1E according to the present embodiment can lift the reading unit 5 vertically upward by the lifting mechanism 63E including the rotation body 633 and the arm portion 634 that is coupled to the rotation body 633 and the reading unit 5 and that moves the reading unit 5 upward and downward along with the rotation of the rotation body 633. The arm portion 634C can be regarded as being coupled to the first reading unit 51 by placing the first reading unit 51 on the arm portion 634C.

The present disclosure is not limited to the embodiments described above and can be implemented in various configurations without departing from the gist of the present disclosure. Technical features in the embodiments corresponding to technical features in the aspects described in the summary of the disclosure can be substituted and combined as appropriate in order to solve a part or all of the problems described above or in order to achieve a part or all of the effects explained above. Further, any of the technical features can be deleted as appropriate unless described as essential in the present specification.

What is claimed is:

1. An image reading apparatus comprising:
a reading unit including a reader configured to read an image on a medium conveyed in a first direction, and a light transmitting member disposed between the reader and a conveyance path through which the medium passes when the image on the medium is read by the reader; and
a cleaning unit configured to clean the light transmitting member when coming into contact with the light transmitting member and moving on the light transmitting member in a second direction intersecting the first direction, wherein
the cleaning unit includes a wiping portion configured to come into contact with the light transmitting member,
the wiping portion is movable in the second direction from a standby position located before start of cleaning to a restriction position where a movement in the second direction is restricted, and
a range from the standby position to the restriction position for the wiping portion in the second direction is a length including both end portions of a medium having a maximum size in the second direction assumed to be used.

2. The image reading apparatus according to claim 1, wherein
the reading unit includes
a first reading unit that includes a first reader serving as the reader configured to read a first surface of the medium conveyed in the first direction and that includes a first light transmitting member serving as the light transmitting member disposed between the conveyance path and the first reader, and
a second reading unit that includes a second reader serving as the reader configured to read a second surface opposite to the first surface and provided on an opposite side to the first reader across the conveyance path and that includes a second light transmitting member serving as the light transmitting member disposed between the conveyance path and the second reader, and
the first reading unit and the second reading unit face each other across the conveyance path.

3. The image reading apparatus according to claim 2, wherein
the cleaning unit is configured to clean the first light transmitting member and the second light transmitting member at a same time.

4. The image reading apparatus according to claim 3, wherein
a thickness of the wiping portion, which is a length in a facing direction in which the first reading unit and the second reading unit face each other when the wiping portion is not located between the first light transmitting member and the second light transmitting member, is larger than a distance between the first light transmitting member and the second light transmitting member in the facing direction.

5. The image reading apparatus according to claim 3, wherein
the wiping portion is configured to clean the first light transmitting member on a first cleaning surface that comes into contact with the first light transmitting member and clean the second light transmitting member on a second cleaning surface that comes into contact with the second light transmitting member.

6. The image reading apparatus according to claim 2, wherein
the cleaning unit includes a first cleaning unit configured to clean the first light transmitting member and a second cleaning unit configured to clean the second light transmitting member.

7. The image reading apparatus according to claim 1, wherein
the cleaning unit includes a first drive motor that is a power source of the wiping portion, and a drive belt that pulls the wiping portion along with rotation of the first drive motor.

8. The image reading apparatus according to claim 1, wherein
the wiping portion is movable from the restriction position to the standby position when the wiping portion is moved in a direction opposite to the second direction.

9. The image reading apparatus according to claim 1, wherein
the restriction position overlaps the light transmitting member when viewed in a vertical direction.

10. The image reading apparatus according to claim 1, wherein
a detection unit is provided at the restriction position, and
the wiping portion includes a detection target portion to be detected by the detection unit, and the movement in the second direction is stopped when the detection unit detects the detection target portion.

11. The image reading apparatus according to claim 1, further comprising:
a moving unit configured to move the reading unit, wherein
the moving unit moves the reading unit in a direction of retracting from the conveyance path before the wiping portion starts moving from the standby position to the restriction position, and moves the reading unit in a direction of approaching the conveyance path after the wiping portion finishes moving from the restriction position to the standby position.

12. The image reading apparatus according to claim 11, further comprising:
an operation unit configured to receive a cleaning instruction, wherein
when the operation unit receives the cleaning instruction, the reading unit is moved in the direction of retracting from the conveyance path.

13. The image reading apparatus according to claim 12, wherein
the operation unit is configured to notify information, and notifies completion of cleaning after the wiping portion finishes moving from the restriction position to the standby position.

14. The image reading apparatus according to claim 2, further comprising:
a moving unit configured to move the reading unit, wherein
the moving unit moves the first reading unit in a direction of retracting from the conveyance path before the wiping portion starts moving from the standby position to the restriction position, and
a distance between the first light transmitting member and the second light transmitting member when the moving unit moves the first reading unit in the direction of retracting from the conveyance path is a length in which both the first light transmitting member and the second light transmitting member are configured to come into contact with the wiping portion.

15. The image reading apparatus according to claim 11, wherein
the moving unit includes a lifting mechanism that lifts the reading unit vertically upward, a second drive motor that is a power source of the lifting mechanism, and a drive unit that transmits power of the second drive motor to the lifting mechanism, and
the reading unit is moved in the direction of retracting from the conveyance path when the second drive motor is driven.

16. The image reading apparatus according to claim 15, wherein
the lifting mechanism is provided at both ends of the reading unit in the second direction.

17. The image reading apparatus according to claim 15, wherein
the lifting mechanism is a cam.

18. The image reading apparatus according to claim 15, wherein
the lifting mechanism is a rack and pinion mechanism.

19. The image reading apparatus according to claim 15, wherein
the lifting mechanism includes a rotation body and an arm portion that is coupled to the rotation body and the reading unit and that moves the reading unit upward and downward along with rotation of the rotation body.
